(19) United States
(12) Patent Application Publication
(10) Pub. No.: US 2016/0036737 A1
(43) Pub. Date: Feb. 4, 2016

(54) Instant Messaging

(71) Applicant: Microsoft Corporation, Redmond, WA (US)

(72) Inventors: Mete Atamel, London (GB); Mattia Cinquilli, London (GB); Luca Colantonio, London (GB)

(21) Appl. No.: 14/498,544

(22) Filed: Sep. 26, 2014

(30) Foreign Application Priority Data
Jul. 30, 2014 (GB) 1413512.3

(51) Int. Cl. H04L 12/58; G06F 3/0484; G06F 3/0482; G06F 17/30

(52) U.S. Cl. CPC H04L 51/046; G06F 17/3087; G06F 3/04842; G06F 3/0482

(57) ABSTRACT

An instant messaging communication method implemented by a client application when executed on a user device, the method comprising: detecting selection by a user of the user device to transmit a poll message to at least one further device of an instant messaging communication session over a communications network; receiving a search term input by the user using an input device of the user device; transmitting a search request comprising the search term over the communications network to a network entity configured to perform a search for web content; and automatically populating a plurality of poll option fields in a poll message to be transmitted to the at least one further device based on search results received from the network entity in response to transmitting the search request.

### RELATED APPLICATIONS

This application claims priority under 35 USC §119 or §365 to Great Britain Patent Application No. 1413512.3, filed Jul. 30, 2014, the disclosure of which is incorporate in its entirety.

### BACKGROUND

Packet-based communication systems allow the user of a device, such as a personal computer, to communicate across the computer network using a packet protocol such as Internet Protocol (IP). Packet-based communication systems can be used for various types of communication events. Communication events which can be established include voice calls, video calls, instant messaging, voice mail, file transfer and others. These systems are beneficial to the user as they are often of significantly lower cost than fixed line or mobile networks. This may particularly be the case for long-distance communication. To use a packet-based system, the user installs and executes client software on their device. The client software provides the packet-based connections as well as other functions such as registration and authentication.

Communications systems allow users of devices to communicate across a computer network such as the internet. Communication events which can be established include voice calls, video calls, instant messaging, voice mail, file transfer and others.

An instant messaging communication session allows a chat to be conducted between users of computer devices via a computer network. Each user can enter text into a field, actuate a send button and thereby create an instant message which is communicated to another user.

It is known for a user of an instant messaging communication session to create a poll and share the poll with other users of the instant messaging communication session during the session to receive their feedback. The user creating the poll specifies each poll option manually. For example, a user creating a poll to enable a group of friends to decide where to go for lunch finds out the names of nearby restaurants, enters them manually as poll options and shares the poll with the rest of the group.

### SUMMARY

The inventors have recognised that the process of the manual creation of a poll is tedious for the user. For example the user creating typically has to use a web browser or other software application running on their device to find the poll options and then create and share the poll using a communication client application.

According to one aspect of the present disclosure there is provided an instant messaging communication method implemented by a client application when executed on a user device, the method comprising: detecting selection by a user of said user device to transmit a poll message to at least one further device of an instant messaging communication session over a communications network; receiving a search term input by said user using an input device of said user device; transmitting a search request comprising said search term over said communications network to a network entity configured to perform a search for web content; and automatically populating a plurality of poll option fields in a poll message to be transmitted to said at least one further device based on search results received from said network entity in response to transmitting said search request.

According to a further aspect of the present disclosure there is provided a user device comprising: an input device; a network interface configured to transmit and receive messages between the user device and at least one further user device over a communication network during an instant messaging communication; one or more processors configured to run a client application, wherein the client application is configured to: detect selection by a user of said user device to transmit a poll message to at least one further device of an instant messaging communication session over a communications network; receive a search term input by said user using said input device; transmit a search request comprising said search term over said communications network via said network interface to a network entity configured to perform a search for web content; and automatically populate a plurality of poll option fields in a poll message to be transmitted to said at least one further device based on search results received from said network entity via said network interface in response to transmitting said search request.

According to another aspect of the present disclosure there is provided a computer program product, the computer program product being embodied on a computer-readable medium and configured so as when executed on a processor to perform any of the methods described herein.

According to one aspect of the present disclosure there is provided a computer program product, the computer program product being embodied on a computer-readable medium and configured so as when executed on a processor of a user device to: detect selection by a user of said user device to transmit a poll message to at least one further device of an instant messaging communication session over a communications network; receive a search term input by said user using an input device of said user device; determine the location of a said user device; transmit a search request comprising said search term and an indication of said location over said communications network to a network entity configured to perform a search for locations of interest based on a received search term and received location information; and automatically populate a plurality of poll option fields in a poll message to be transmitted to said at least one further device based on search results received from said network entity in response to transmitting said search request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present disclosure and to show how the same may be put into effect, reference will now be made, by way of example, to the following drawings in which:

FIG. 1 shows a communication system;

FIG. 2 shows a schematic view of a user terminal;

FIG. 3 is a flow chart for a process of generating a poll message;

FIG. 4a illustrates a user terminal displaying a chat window of a communication client application;

FIG. 4b illustrates a user terminal displaying a first poll generation window of a communication client application;

FIG. 4c illustrates a user terminal displaying a second poll generation window of a communication client application;

FIG. 4d illustrates a user terminal displaying a third poll generation window of a communication client application; and

FIG. 4e illustrates a user terminal displaying a transmitted poll in a chat window of a communication client application; and

FIG. 5 is a flow chart for a process of editing a poll message.

### DETAILED DESCRIPTION

Embodiments will now be described by way of example only.

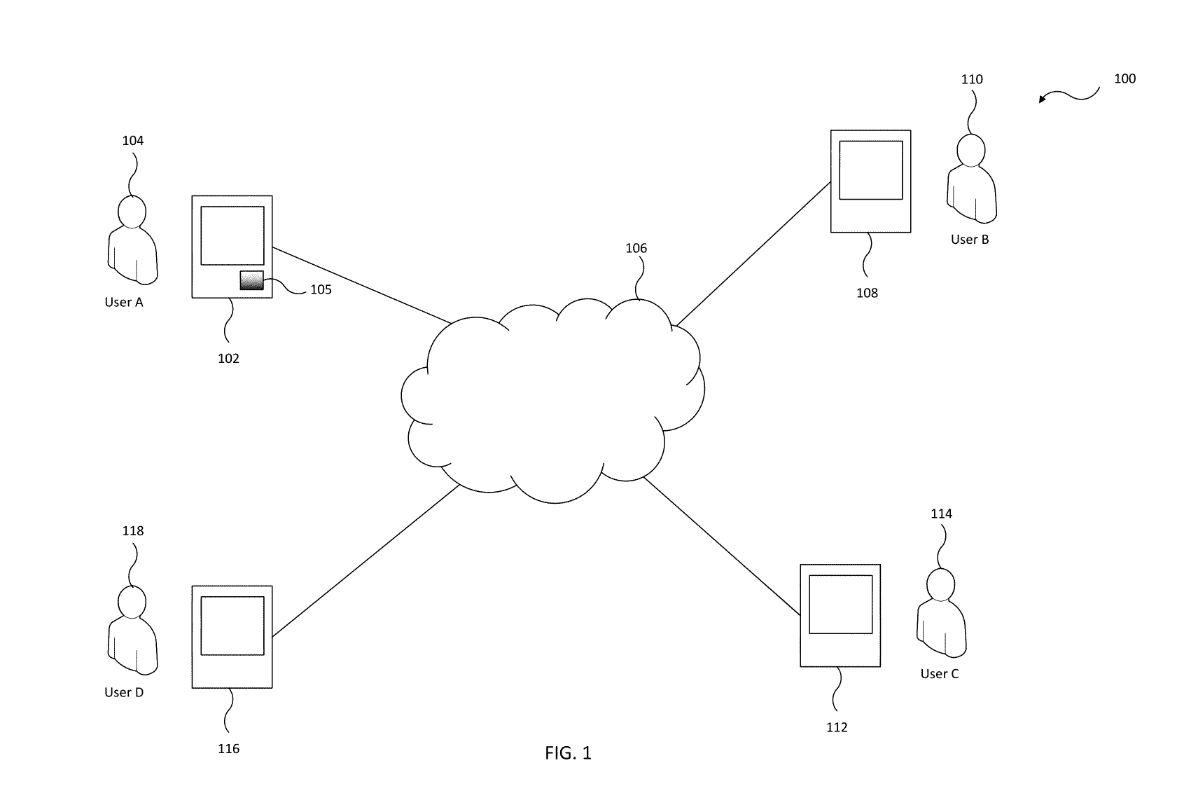

FIG. 1 shows a communication system 100 comprising a first user 104 (User A) who is associated with a user terminal 102, a second user 110 (User B) who is associated with a user terminal 108, a third user 114 (User C) who is associated with a user terminal 112, and a fourth user 118 (User D) who is associated with a user terminal 116. The user terminals can communicate over a communication network 106 in the communication system 100, thereby allowing the users to communicate with each other over the communication network 106. The communication network 106 may be any suitable network which has the ability to provide a communication channel between the user terminals. For example, the communication network 106 may be the Internet or another type of network such as a High data rate mobile network, such as a 3^{rd} generation (“3G”) mobile network.

Note that in alternative embodiments, user terminals can connect to the communication network 106 via an additional intermediate network not shown in FIG. 1. For example, if a user terminal is a mobile device, then it can connect to the communication network 106 via a cellular mobile network (not shown in FIG. 1), for example a GSM or UMTS network.

The user terminals may be, for example, a mobile phone, a personal digital assistant (“PDA”), a personal computer (“PC”) (including, for example, Windows™, Mac OS™ and Linux™ PCs), a tablet computer, a gaming device or other embedded device able to connect to the communication network 106.

The user terminal 102 executes a communication client application 105, provided by a software provider associated with the communication system 100. The communication client application 105 is a software program executed on a local processor in the user terminal 102. The communication client application 105 performs the processing required at the user terminal 102 in order for the user terminal 102 to transmit and receive data over the communication system 100. The communication client application 105 executed at the user terminal 102 may be authenticated to communicate over the communication system through the presentation of digital certificates (e.g. to prove that user 104 is a genuine subscriber of the communication system—described in more detail in WO 2005/009019).

The user terminals 108, 112, 116 each execute on a local processor, a communication client application which corresponds to the communication client application 105 executed at the user terminal 102. The user terminals shown in FIG. 1 are end points in the communication system. FIG. 1 shows only four users and four user terminals for clarity, but many more users and user devices may be included in the communication system 100, and may communicate over the communication system 100 using respective communication clients executed on the respective user devices, as is known in the art.

The messages exchanged during an instant messaging communication session are transmitted over the network 106. They may be transmitted via a network entity (e.g. a server) connected to the network 106 between the user terminals. Alternatively or additionally, the messages of the communication session may be transmitted on point-to-point routes between the user terminals (i.e. a route that does not go via any server in the communication system 100), as is known in the art

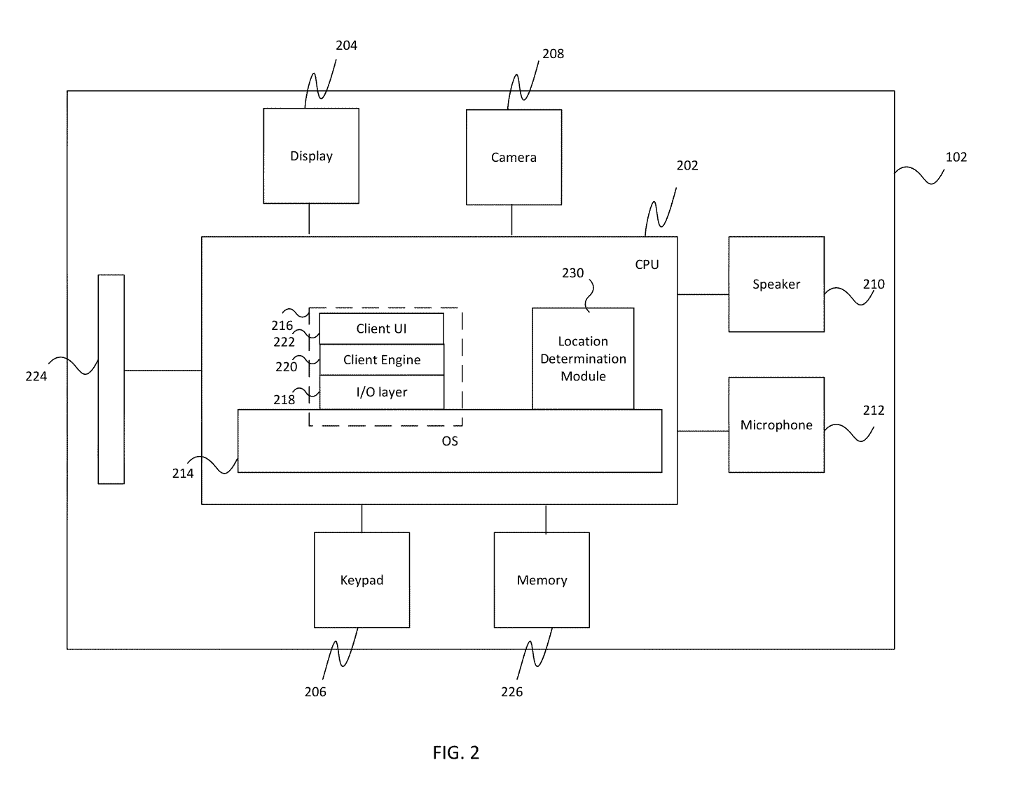

FIG. 2 illustrates a detailed view of the user terminal 102 on which is executed a communication client application for communicating over the communication system 100. The user terminal 102 comprises a central processing unit (“CPU”) 202, to which is connected a display 204 such as a screen or touch screen, input devices such as a keypad 206, a camera 208, and touch screen 204. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 102 as shown in FIG. 2. In alternative user terminals one or more of the display 204, the keypad 206, the camera 208, the output audio device 210 and the input audio device 212 may not be integrated into the user terminal 102 and may be connected to the CPU 202 via respective interfaces. One example of such an interface is a USB interface. The CPU 202 is connected to a network interface 224 such as a modem for communication with the communication network 106. The network interface 224 may be integrated into the user terminal 102 as shown in FIG. 2. In alternative user terminals the network interface 224 is not integrated into the user terminal 102. The user terminal 102 also comprises a memory 226 for storing data as is known in the art. The memory 226 may be a permanent memory, such as ROM. The memory 226 may alternatively be a temporary memory, such as RAM.

The user terminal 102 is installed with the communication client application 105, in that the communication client application 105 is stored in the memory 226 and arranged for execution on the CPU 202. FIG. 2 also illustrates an operating system (“OS”) 214 executed on the CPU 202. Running on top of the OS 214 is a software stack 216 for the communication client application 112 referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the communication network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user terminals of the communication system 100. The client engine layer 220 handles the connection management functions of the VoIP system as discussed above, such as establishing calls or other connections by server-based or P2P address look-up and authentication. The client engine may also be responsible for other secondary functions not discussed herein. The client engine 220 also communicates with the client user interface layer 222. The client engine 220 may be arranged to control the client user interface layer 222 to present information to the user of the user terminal 102 via the user interface of the client which is displayed on the display 204 and to receive information from the user the user terminal 102 via the user interface.

### Poll Message Creation

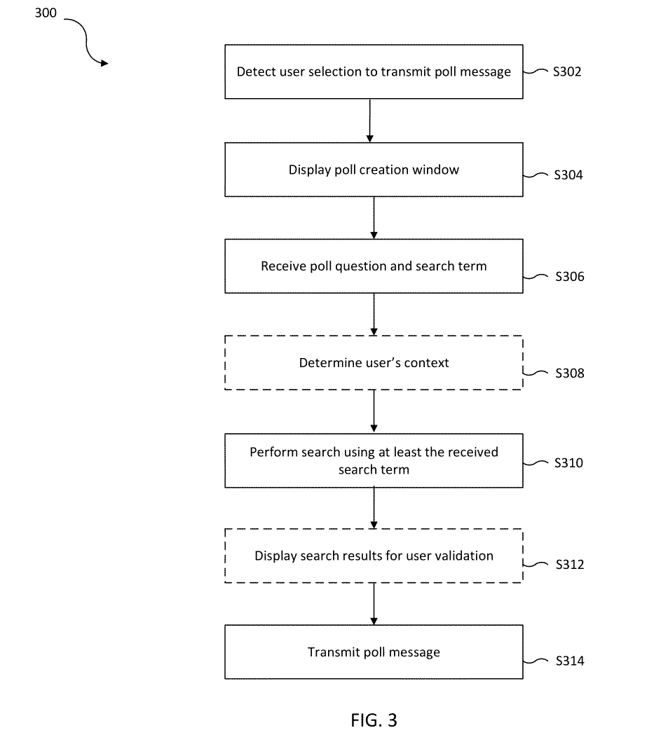

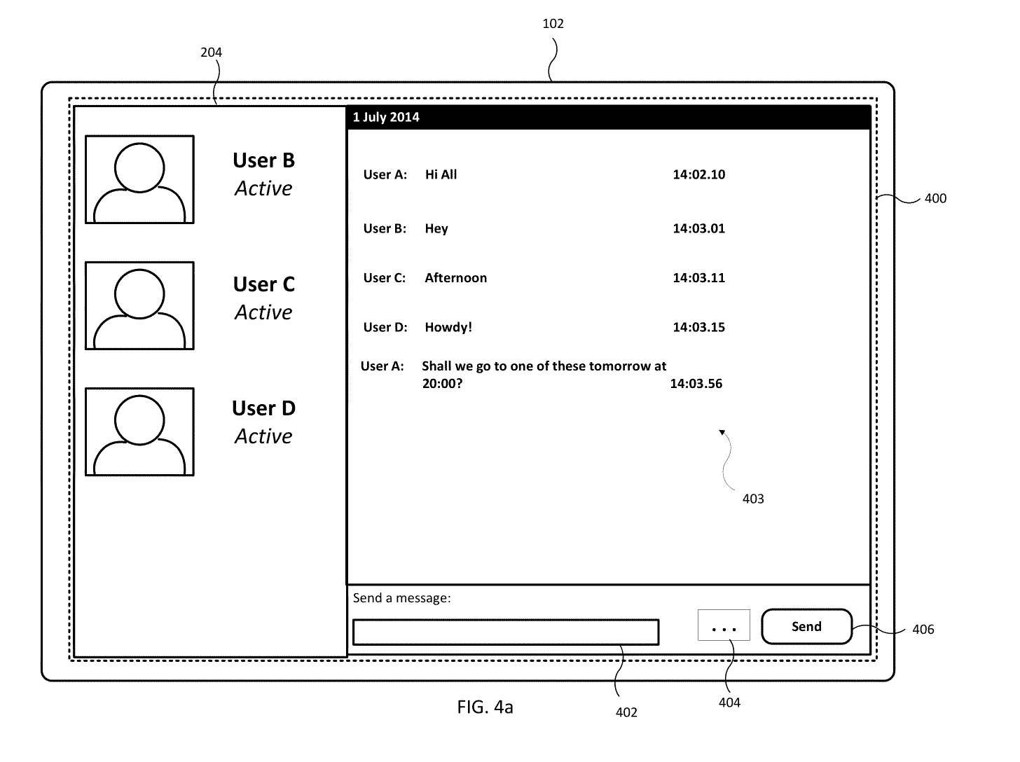

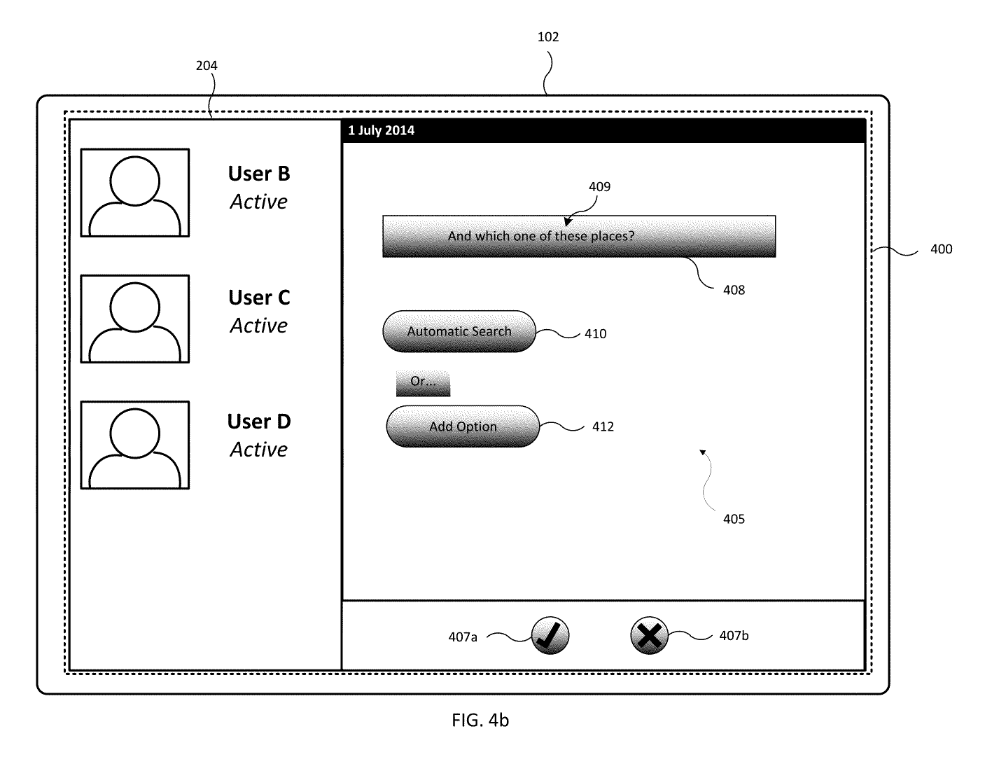

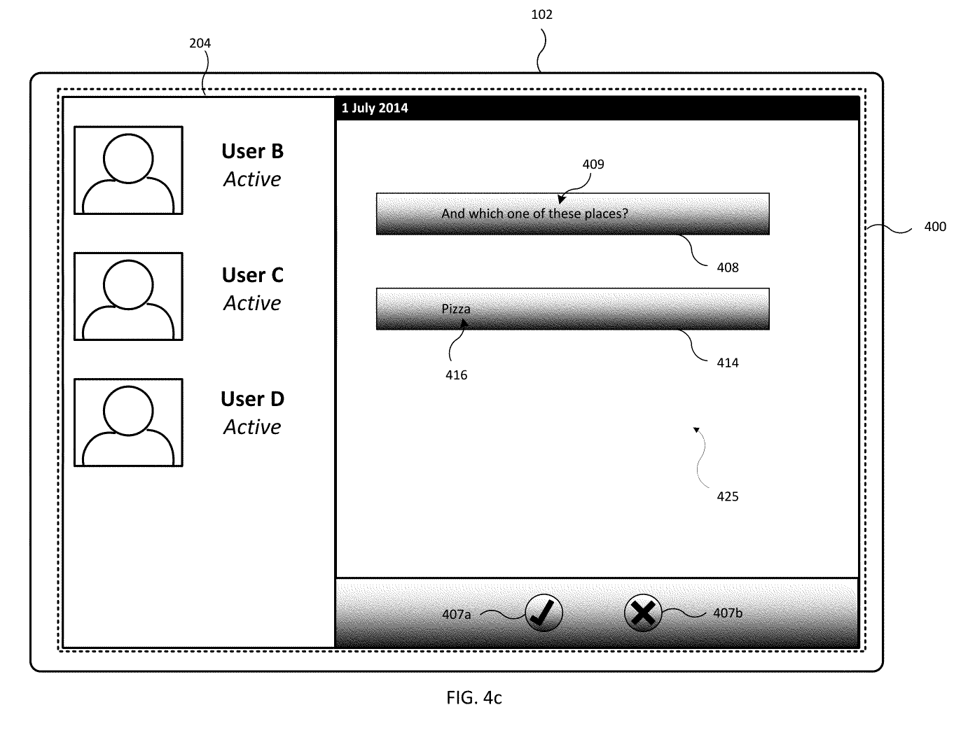

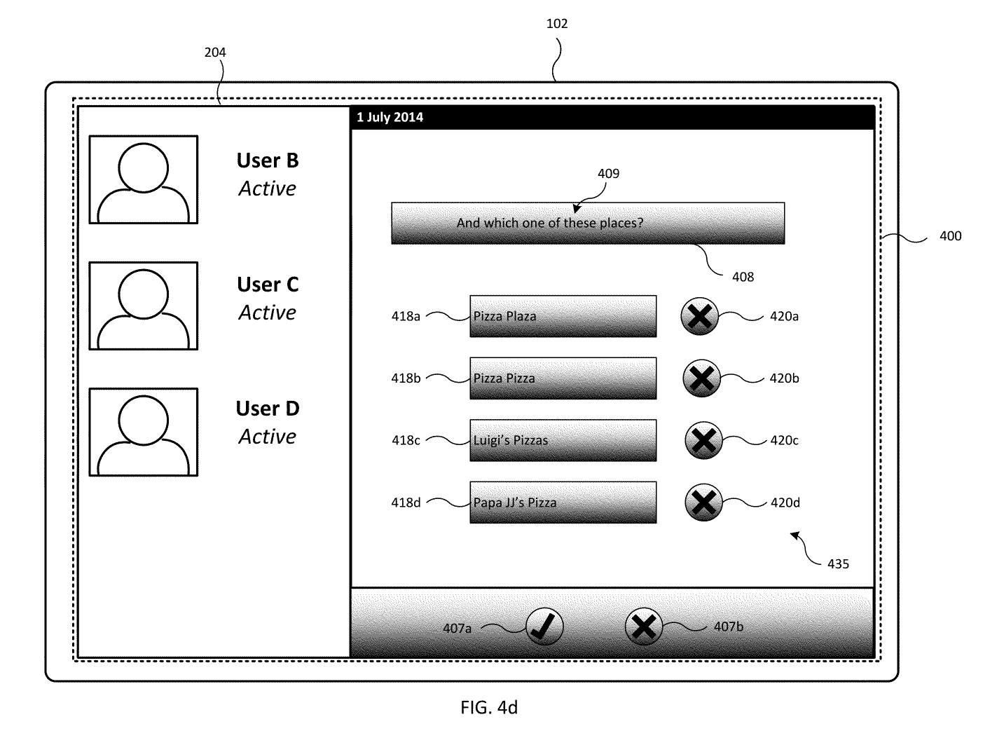

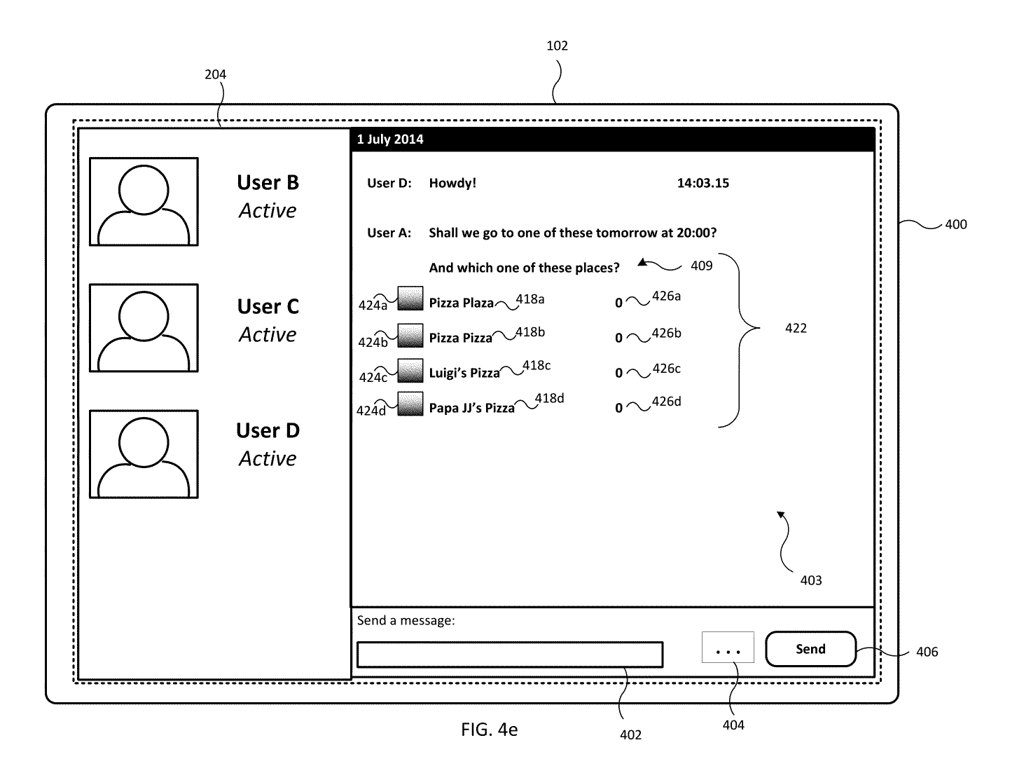

A method implemented during an instant messaging communication session between a plurality of user devices (otherwise referred to as user terminals herein) over the communications network 106 will now be described with reference to FIG. 3 which is a flow chart for a process 300 performed by the client application 105 executed on user terminal 102 for generating a poll message. Reference will also be made to FIGS. 4a, 4b, 4c, 4d and 4e which illustrate exemplary client user interfaces presented in various embodiments as part of the process 300.

Embodiments of the present disclosure are described with reference to User A 104, User B 110, User C 114 and User D 118 engaging in an instant messaging conversation whereby messages may be transmitted and received between the user terminals 102, 108, 112, and 116 in an instant messaging communication session.

The client user interface provided by the communication client application 105 executed on user terminal 102 is operable to display text input by User A 104 to be transmitted in a message of the instant messaging communication session but which has not yet been transmitted. Specifically, the communication client application 105 displays via the client user interface a message field 402 (shown in FIG. 4a) into which User A 104 is able to enter text using for example the touch screen 204 or keypad 206. The client user interface displays a selectable send option 408 which User A 104 can select after inputting such text. In response, the communication client application 105 creates a message containing the input text and transmits the created message via the communication network 106 to the user terminals 108, 112, 116. Messages transmitted from user terminal 102 and messages received from user terminals 108, 112, 116 are displayed in a chat window 403.

At step S302, the communication client application 105 detects a selection in the by User A 104 to transmit a poll message to Users B-D based on detecting an interaction with the client user interface provided by the communication client application 105. The communication client application 105 may display via the client user interface a menu button (404 in FIGS. 4a and 4e) which User A 104 is able to select using an appropriate input device such as a mouse (not shown in FIG. 2), keypad 206 or using the touch screen 204. By navigating through menu options User A 104 is able to make an appropriate selection to transmit a poll message to Users B-D. Alternatively or additionally, the communication client application 105 may display via the client user interface a dedicated button for the transmission of a poll message.

In response to the detection at step S302, the process 300 proceeds to step S304. At step S304 the communication client application 105 displays via the client user interface a first poll generation window 405. The first poll generation window 405 is shown in FIG. 4b.

At step S306 the communication client application 105 receives a poll question and search term.

As shown in FIG. 4b the first poll generation window 405 comprises a poll question entry field 408. A poll question can be entered by User A 104 in the poll question entry field 408 using an appropriate input device such as keypad 206 or using the touch screen 204. FIG. 4b illustrates an example poll question 409 “And which one of these places?” that has been entered into the poll question entry field 408.

The first poll generation window 405 comprises a first selectable icon 410 and a second selectable icon 412. User A 104 selects the first selectable icon 410 if he wants the communication client application 105 to perform an automatic search for poll options, and the second selectable icon 412 if he wants to manually enter poll options.

In response to detecting selection of the first selectable icon 410, the communication client application 105 may display via the client user interface a second poll generation window 425 (shown in FIG. 4c). Alternatively, after selecting the first selectable icon 410, User A 104 may select a selectable button 407a to navigate to the second poll generation window 425.

As shown in FIG. 4c the second poll generation window 425 comprises a search term entry field 414.

A search term can be entered by User A 104 in the search term entry field 414 using an appropriate input device such as keypad 206 or using the touch screen 204. FIG. 4c illustrates an example search term 416 “Pizza” that has been entered into the poll question entry field 408.

User A 104 may select a selectable button 407a to navigate to a third poll generation window 435.

At step S308 the communication client application 105 optionally determines User A's context. In one example step S308 comprises determining the location of the user terminal 102 (thereby determining the location of User A 104).

The communication client application 105 may determine the location of the user terminal 102 in various ways.

In one example, the communication client application 105 may determine the location of the user terminal 102 by communicating with a location determination module 230 running on top of the OS 214. The location determination module 230 is configured to determine the location of the user terminal 102. The location determination module 230 uses geographic location technology for determining the location of the user terminal 102, in terms of geographic position relative to the surface of the earth; for example, a satellite based positioning system such as GPS (Global Positioning System, including potential variants such as assisted GPS or differential GPS), GLONASS (Global Navigation Satellite System) or Galileo; and/or trilateration (or more generally muiltilateration) relative to a plurality of different wireless base stations or access points having known locations; and/or a technique based on detecting signal strength relative to a known base station or access point. Other well-known methods may be used for the user terminal 102 to determine its location. In this example, the communication client application 105 determines the location of the user terminal 102 based on location information (e.g. latitude/longitude information) received from the location determination module 230 in response to transmitting a request for location information to the location determination module 230.

The communication client application 105 may determine the location of the user terminal 102 based on an indication of the location of the user terminal 102 selected or entered by User A 104. For example, User A 104 may manually enter his location in the client user interface provided by the communication client application 105. In another example, User A 104 may select an online presence status or enter a mood message in the client user interface provided by the communication client application 105 that provides an indication of User A's location (e.g. indicates that he is in a particular city, state or country).

In another example, the communication client application 105 may determine the location of the user terminal 102 based on machine learning techniques. For example, the communication client application 105 may communicate with the location determination module 230 at various times of the day (this may be done periodically e.g. once an hour) and if the user terminal 102 is in the same area for an extended period of time (configured by the provider of the communication client application 105), the communication client application 105 could deduce User A's work location (based on location of user terminal 102 between 8 am-5 pm) and User A's home location (based on location of user terminal 102 from 6 pm onwards). Thus based on the time of day, the communication client application 105 is able to predict the location of the user terminal 102 at one of these expected locations.

Other context information of User A 104 may comprise the User A's age, language, nationality, and gender etc. The communication client application 105 is able to determine this other context information based on profile information entered by User A 102. The context information may also comprise the time of day.

At step S310, the communication client application 105 performs a search using at least the search term 416. Step S310 comprises the communication client application 105 transmitting a search request comprising the search term 416 to a web server (not shown in FIG. 1) coupled the network 106. The web server is configured to execute web search engine software to search for content on the World Wide Web. An exemplary search engine is the Bing™ search engine provided by Microsoft®.

If step S308 is performed, the context information is included in the search request in the search term or search parameters depending on the search method used. The context information is provided as this assists in providing search results that are more relevant to User A 104 to the communication client application 105. For example, if location information is included in the search request, the communication client application 105 is configured to transmit the search request to the web server which is configured to return search results of locations of interest in the vicinity of the user terminal 102 based on the search term 416 and the location information. For example using an application programming interface (API) e.g. Microsoft Bing Points of Interest API, enables the web server to search a database in the network 106 storing locations of interest and their associated location information based on the search request.

The context information could also be used to pick an appropriate search medium. For example, if the context information includes a user's friends list from a social network (e.g. Facebook®), then the communication client application 105 could perform the search at step S310 in User A's activity feed of the social network. As is known to persons skilled in the art, a user's activity feed displays activity from other users and pages that a user has selected to follow (e.g. status updates, photos, videos, links, and likes).

At step S312 the client application 105 displays a predetermined number of the returned search results in the third poll generation window 435. This predetermined number is determined by the provider of the client application 105.

FIG. 4d illustrates the third poll generation window 435 comprising a plurality of search results 418a-d returned to the client application 105 from the web server in response to the search request.

In an example whereby the search request comprises the search term 416 “Pizza” and the location information of the user terminal 102, the communication client application 105 receives search results about the “Pizza” places geographically located close to the location of the user terminal 102. That is, the plurality of search results 418a-d returned to the client application 105 are locations of interest relating to the search term 416 “Pizza”.

The returned locations of interest 418a-d are to be used as a poll options in a poll message transmitted to Users B-D. FIG. 4d illustrates a first location of interest “Pizza Plaza” 418a, a second location of interest “Pizza Pizza” 418b, a third location of interest “Luigi's Pizzas” 418c, and a fourth location of interest “Papa JJ's Pizza” 418d.

Prior to transmitting the poll message to Users B-D, the poll options may be edited by User A 104. For example, if User A 104 does not want to include one or more of the poll options in the poll message that is to be transmitted to Users B-D, User A 104 may remove one or more of the poll options by selecting a selectable poll option removal icon 420 associated with the respective poll option that is to be removed.

Following detecting the removal of a poll option, the communication client application 105 may be configured to display an alternative location of interest as a poll option that was returned by the web server in response to the search request in place of the removed poll option. Alternatively, the communication client 105 may be configured to simply remove the poll option.

Prior to transmitting the poll message to Users B-D, an additional poll option may be manually entered by User A 104.

Once User A 104 has finished editing the poll options (if necessary) User A 104 may select a selectable button 407a to transmit a poll message comprising the poll question 409 and the poll options 418 to Users B-D.

In response to detecting selection of the selectable button 407a, the communication client application 105 is configured to transmit a poll message 422 over the network 106 to the user terminals associated with each of Users B-D.

FIG. 4e illustrates the transmitted poll message 422 displayed in the chat window 403 of the client user interface provided by the communication client application 105. As shown in FIG. 4e, the transmitted poll message comprises the poll question 409 and the plurality of poll options 418. It will be appreciated that the communication client application executed on each of user terminals 108, 112, and 115 displays the received poll message 422 in a chat window of the client user provided by the respective communication client application.

Embodiments of the present disclosure improves the user experience of a user wishing to generate a poll for use in an instant messaging communication session by automatically generating a poll's options based on the user's context such as location and a search criteria. By automatically generating a poll's options a poll message can be generated quickly and with a reduced number of manual steps that have to be performed by the user wishing to generate the poll.

In contrast to prior art methods, the poll message 422 exchanged during the instant messaging communication session is displayed in the chat window 403 of the client user interface provided by the communication client application 105 i.e. the area in which messages exchanged during the instant messaging communication session are displayed. By displaying the poll message 422 in the chat window 403, continuity of the IM conversation can be maintained and user engagement is increased.

To navigate away from a poll generation window at any point in the process of generating a poll, User A 104 may select a selectable button 407b to return to the chat window 403.

### Editing a Poll Message

For users in a group instant messaging communication session, there is currently no way to collaborate on an already received message. For example, if a user receives a message that requires a feedback (e.g. a vote in a poll message) there is no way for the user to provide that feedback in the context of the original message. Rather, the user has to create and send a new message which unnecessarily duplicates the same information in the chat history of the instant messaging communication session.

Embodiments of the present disclosure allow participants of the instant messaging communication session to edit the transmitted poll message 422 by voting for one or more of the poll options 418.

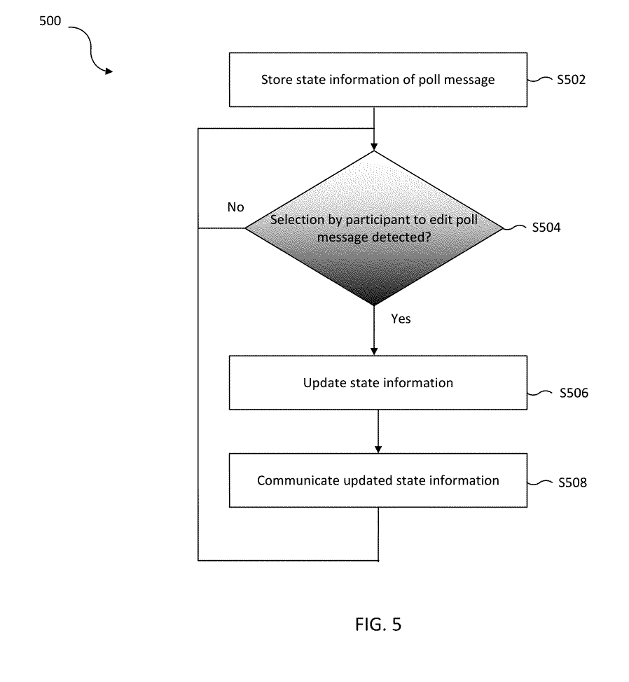

A method implemented during the instant messaging communication session between the user terminals 104, 108, 112, 116 over the communications network 106 will now be described with reference to FIG. 5 which is a flow chart for a process 500 for editing a poll message.

The process 500 may be performed by each communication client application executed on respective user terminals 104, 108, 112, 116. Alternatively, if the messages exchanged during an instant messaging communication session are transmitted over the network 106 via the network entity (e.g. server) connected to the network 106, then the process 500 may be performed by this network entity.

The process 500 will first be described with reference to being performed by a communication client application executed on one of the user terminals involved in the instant messaging communication session, in particular communication client application 105 executed on user terminal 102.

In response to transmitting the poll message 422 over the network 106 to the user terminals associated with each of Users B-D, at step S502 the communication client application 105 is configured to store state information of the poll message 422 in a memory (e.g. memory 226) of user terminal 102. The state information comprises information on a plurality of updateable fields 426 in the poll message. The state information may further comprise the message identifier of the poll message 422, the poll question 409, and the poll options 418.

Each of the poll options 418 of the poll message 422 are associated with an updateable field 426. An updateable field 426 indicates user feedback in relation to its associated poll option. Embodiments will be described below with reference to the plurality of updateable fields 426 comprising a counter value indicating the number of votes for its associated poll option (as shown in FIG. 4e) however the updateable fields may take many different forms as will be described in more detail later.

When the poll message 422 is transmitted over the network 106 to the user terminals associated with each of Users B-D, the counter values are set to a default initial value (i.e. zero). Thus the state information stored in memory 226 of the plurality of updateable fields 426 following transmission of the poll message 422 comprises these default initial counter values.

At step S504, the communication client application 105 detects whether a participant in the instant messaging communication session has selected to edit the poll message 422.

Any of Users A-D can cast a vote for one of the plurality of poll options 418 by selecting the poll option that they wish to vote for using their respective user terminal. In response to detecting a selection of one of the poll options 418 by a user (i.e. to edit the counter value associated with the selected poll option) the process 500 proceeds to step S506.

At step S506, the communication client application 105 updates the counter value associated with the selected poll option that is stored in memory 226 by incrementing the stored counter value by one. The process 500 then proceeds to step S508.

At step S508, the communication client application 105 communicates the updated state information to at least one of the participants of the instant messaging communication session (i.e. Users A-D).

User A 104 can select the poll option in the poll message 422 that he wishes to vote for by making a selection in the user interface provided by the communication client application 105. The communication client application 105 is configured to detect this selection.

As shown in FIG. 4e the poll message 422 may comprise a plurality of selectable icons 424 each associated with a respective poll option 418. User A 104 can select the poll option that he wishes to vote for by selecting the selectable icon 424 associated with the poll option that he wishes to vote for. Alternatively the poll options themselves may be selectable icons which User A 104 can vote for by selecting the poll option that he wishes to vote for. A poll option can be selected by User A 104 using an appropriate input device such as keypad 206, a mouse or using the touch screen 204.

The communication client application 105 communicates the updated state information to User A 104, by modifying the display of the poll message 422 displayed in the user interface on the display 204 of user terminal 102. In particular by displaying an incremented counter value 426 that is associated with the poll option selected by User A 104.

The communication client application 105 is also configured to communicate the detected selection to the respective communication client applications executed on user terminals 108, 112, and 116 so they can update the poll message 422 displayed on these terminals accordingly.

In order to do this, the communication client application 105 generates a poll option selection message comprising a message identifier of the poll message 422, a user identifier identifying User A 102, and an indication of the poll option selected by User A. The communication client application 105 transmits the generated a poll option selection message over the communications network 106 to user terminals 108, 112, and 116.

The communication client application 105 is configured to detect a selection by one of the other participants (User B-D) of a poll option that they wish to vote for based on receiving a poll option selection message from the participant's user terminal (e.g. one of user terminal 108, 112, and 116). The communication client application 105 is configured to determine the poll message (i.e. poll message 422) that the poll option selection message relates to, based on the message identifier in the poll option selection message, and detect the selected poll option indicated in the poll option selection message. Thus the communication client application 105 is able to update the counter value associated with the selected poll option that is stored in memory 226 by incrementing the stored counter value by one, and communicate the updated state information to User A 104, by modifying the display of the poll message 422 displayed in the user interface on the display 204 of user terminal 102. In particular by displaying an incremented counter value 426 that is associated with the selected poll option.

Each of the communication clients executed on user terminals 108, 112, and 116 are configured to operate in the same manner as described above for the communication client application 105. Thus each of the users involved in the instant messaging communication session can vote on the plurality of poll options 418 and the vote count associated with each poll option 418 in poll message 422 is updated in response to the users' votes.

As described above, if the messages exchanged during an instant messaging communication session are transmitted over the network 106 via the network entity (e.g. server) connected to the network 106, then the process 500 may be performed by this network entity.

In this embodiment, the network entity is configured to store the state information of the poll message 422 in memory of the network entity or in an external storage location in the network 106 accessible by the network entity.

In response to a communication client application executed on one of the user terminals 102, 108, 112, and 116 detecting a selection of one of the poll options 418 by a user associated with the user terminal on which the communication client application is executed, the communication client application generates a poll option selection message comprising a message identifier of the poll message 422, a user identifier identifying the user, and an indication of the poll option selected by the user. The communication client application transmits the generated poll option selection message over the communications network 106 to the network entity.

The network entity maintains a list of users and their poll responses (the poll option selected by each user) for a particular poll message (identified by the message identifier of the poll message) in its memory (or stored in external storage). From this list the network entity determines the number of votes for a certain poll option, and communicates the state information to all of the participants of the instant messaging communication session (i.e. Users A-D). This is needed in order to avoid a single user being able to vote for more than one of the plurality of poll options 418.

As described above, a poll message may restrict a single user to vote for only one of the plurality of poll options 418. Alternatively a poll message may allow a single user to vote for more than one of the plurality of poll options 418. For poll messages that restrict a single user to vote for only one of the plurality of poll options 418, the entity maintaining the state information of the poll message (a communication client application or network entity) is operable to prevent a user from voting for more than one of the plurality of poll options, or from voting for the same poll option more than once, based on the message identifier of the poll message 422 and a user identifier identifying the user. That is, the entity maintaining the state information of the poll message is able to detect whether the particular user has already voted for one of the poll options 418, and if so prevent the update of the state information in response to a further vote from the user.

Whilst embodiments have been described above with reference to the plurality of updateable fields 426 comprising a counter value indicating the number of votes for its associated poll option (as shown in FIG. 4e) this is merely one example way of indicating user feedback in relation to the poll options 418. The updateable fields 426 may take many different forms.

For example, each of the plurality of updateable fields 426 may comprise a numerical value indicating the percentage of the total votes cast for the particular poll option. When the poll message 422 is transmitted over the network 106 to the user terminals associated with each of Users B-D, the percentage values are set to an initial value (0%). The entity maintaining the state information of the poll message updates the percentage values associated with the poll options that is stored in memory by calculating new percentage values following detection of Users A-D casting votes for the plurality of poll options 418.

In another example, each of the plurality of updateable fields 426 may comprise a star rating (e.g. out of 5 stars) indicating the average star rating cast for the particular poll option. When the poll message 422 is transmitted over the network 106 to the user terminals associated with each of Users B-D, the star ratings are set to an initial value (e.g. zero). The entity maintaining the state information of the poll message updates the star rating associated with a poll option that is stored in memory by calculating the average (mean) star rating following detection of Users A-D casting one or more votes for the poll option.

Embodiments of the present disclosure extend to other methods of indicating user feedback in relation to the poll options 418 that will be apparent to persons skilled in the art.

Although not shown in the figures a communication client application displaying a poll message exchanged during the instant messaging communication session may be configured to indicate how many users have voted for each of the poll options 418 and/or the usernames (used to uniquely identify users of the communication system to other users) of the users who have voted for each of the poll options 418.

It will be appreciated from the embodiments described above that the poll message 422 is editable by a user of the instant messaging communication session by way of casting a vote/providing a rating for one or more of the poll options 418. In addition the poll message may be editable in other ways.

For example, a user of the instant messaging communication session may comment on a poll option by entering text in a comment field (not shown in the Figures) of the poll message. Text can be inserted into a comment field by a user using an appropriate input device such as keypad 206, or using the touch screen 204. This allows a user to provide additional feedback in relation to the poll option. For example with reference to the poll options 418 of the poll message 422 shown in FIG. 4e, a user may comment as a mere example “already been here this week!”, “this place is closed for refurbishment” or “always wanted to go here”. Thus it will be appreciated that a comment inserted into the poll message by one user of the instant messaging communication session may affect the voting of the other users of the instant messaging communication session.

Embodiments of the present disclosure enable users to provide feedback to a message that requires feedback in the context of the original message. This avoids unnecessary duplication of the same information in the chat history of the instant messaging communication session.

Embodiments of the present disclosure are described above with reference to the client user interface displaying content in an available area 400 of the display 204. As depicted in FIGS. 4a-e the available area of the display is the whole of the display. However, it is envisaged that the available area of the display (that is the area available to the client 105) may constitute only a portion of the display e.g. with the remainder of the display being used by the operating system and/or other application(s) executed thereon to display other content.

The steps shown separately in FIGS. 3 and 5 may or may not be implemented as separate steps.

Generally, any of the functions described herein can be implemented using software, firmware, hardware (e.g., fixed logic circuitry), or a combination of these implementations. The terms “controller”, “functionality”, “component”, and “application” as used herein generally represent software, firmware, hardware, or a combination thereof. In the case of a software implementation, the controller, functionality, component or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An instant messaging communication method implemented by a client application when executed on a user device, the method comprising:
detecting selection by a user of said user device to transmit a poll message to at least one further device of an instant messaging communication session over a communications network;
receiving a search term input by said user using an input device of said user device;
transmitting a search request comprising said search term over said communications network to a network entity configured to perform a search for web content; and
automatically populating a plurality of poll option fields in a poll message to be transmitted to said at least one further device based on search results received from said network entity in response to transmitting said search request.

2. The method of claim 1, further comprising determining context information of a user of said user device and including said determined context information in said search request.

3. The method of claim 2, wherein the context information comprises a location of said user device, and the received search results are locations of interest based on said search term and the location of said user device.

4. The method of claim 3, wherein determining the location of said user device comprises transmitting a request for said location information to a location determination module of said user device, and receiving the location information from said location determination module in response to transmitting said request.

5. The method of claim 3, wherein the location information comprises latitude and longitude information.

6. The method of claim 3, wherein determining the location of said user device comprises receiving location information manually input by said user using said input device.

7. The method of claim 3, wherein determining the location of said user device comprises determining at least one expected location of the user device during time periods of a day using location information received from a location determination module of said user device, and predicting the location of said user device at one of said at least one expected locations using time of day information.

8. The method of claim 1, said client application having a user interface and the detecting the selection by the user comprises detecting an interaction with said user interface by said user.

9. The method of claim 8, further comprising displaying the poll message to be transmitted in said user interface on a display of said user device.

10. The method of claim 9, wherein the displayed poll message to be transmitted comprises a plurality of selectable poll option removal icons, each selectable poll option removal icon associated with one of said plurality of poll option fields.

11. The method of claim 10, further comprising detecting selection of one of said selectable poll option removal icons, and removing the poll option field associated with the selected selectable poll option removal icon from the poll message to be transmitted.

12. The method of claim 10, further comprising detecting selection of one of said selectable poll option removal icons, and replacing the search result of the poll option field associated with the selected selectable poll option removal icon with a further search result of said received search results.

13. The method of claim 8, further comprising transmitting the poll message to be transmitted to the at least one further device over said communications network.

14. The method of claim 13, further comprising displaying the transmitted poll message in said user interface in a display area in which messages exchanged between the user device and said at least one further device during the instant messaging communication session are displayed.

15. The method of claim 1, further comprising receiving a poll question input by said user using said input device and populating a poll question field in the poll message to be transmitted with the received poll question.

16. The method of claim 2, wherein the context information comprises characteristics of the user of said user device.

17. The method of claim 16, wherein characteristics of the user of said user device comprise one or any combination of: age, language, nationality, gender.

18. The method of claim 2, wherein the context information comprises time of day information.

19. A user device comprising:
an input device;
a network interface configured to transmit and receive messages between the user device and at least one further user device over a communication network during an instant messaging communication;
one or more processors configured to run a client application, wherein the client application is configured to:
detect selection by a user of said user device to transmit a poll message to at least one further device of an instant messaging communication session over a communications network;
receive a search term input by said user using said input device;
transmit a search request comprising said search term over said communications network via said network interface to a network entity configured to perform a search for web content; and
automatically populate a plurality of poll option fields in a poll message to be transmitted to said at least one further device based on search results received from said network entity via said network interface in response to transmitting said search request.

20. A computer program product, the computer program product being embodied on a computer-readable medium and configured so as when executed on a processor of a user device to:
detect selection by a user of said user device to transmit a poll message to at least one further device of an instant messaging communication session over a communications network;
receive a search term input by said user using an input device of said user device;
determine the location of a said user device;
transmit a search request comprising said search term and an indication of said location over said communications network to a network entity configured to perform a search for locations of interest based on a received search term and received location information; and
automatically populate a plurality of poll option fields in a poll message to be transmitted to said at least one further device based on search results received from said network entity in response to transmitting said search request.
